(19) United States
(12) Patent Application Publication
(10) Pub. No.: US 2007/0035951 A1
(43) Pub. Date: Feb. 15, 2007

(54) Lighting equipment for a kitchen ventilator

(76) Inventor: Yin-Hsiu Tseng, Caotun Township (TW)

Correspondence Address: CHARLES E. BAXLEY, ESQ., 90 JOHN STREET, THIRD FLOOR, NEW YORK, NY, 10038, US

(21) Appl. No.: 11/502,967

(22) Filed: Aug. 9, 2006

(30) Foreign Application Priority Data
Feb. 17, 2006 (TW) 095105484
Aug. 12, 2005 (TW) 094213864

(51) Int. Cl. F21V 29/00

(52) U.S. Cl. 362/294; 362/147; 362/346

(57) ABSTRACT

A lighting equipment is provided in the housing of a kitchen ventilator with a plurality of LEDs. When the light equipment is turned on, power will be transmitted by a circuit to the LEDs, the LEDs are power saving, and the light of the LEDs is stable and irradiant. The lighting equipment comprises a base, a plurality of elastic locking pieces, and a circuit board. The elastic locking pieces enables a quick installation of the lighting equipment into the kitchen ventilator housing. Further, the base, the plurality of elastic locking pieces, and the circuit board are assembled by using a single screw and a nut. Therefore, the lighting equipment for a kitchen ventilator, which can be easily assembled and disassembled.

### BACKGROUND OF THE INVENTION

1. Field of the Invention

The present invention relates to a lighting equipment for a kitchen ventilator, and more particularly to a LED type lighting equipment for a kitchen ventilator, which comprises a base, a plurality of elastic locking pieces, and a circuit board. The lighting equipment is not only power saving and has improved brightness, but also can be easily assembled and disassembled, and

2. Description of the Prior Art

A conventional lighting equipment for a kitchen ventilator is shown in FIGS. 1 and 2 and comprises a base 1 installed in the housing of a kitchen ventilator. A reflecting board 11 is disposed in the base 1, a light bulb 12 is located in front the reflecting board 11, and then a light holder 13 is arranged between the light bulb 12 and the base 1 for holding the light bulb 12. An elastic locking piece 14 is set on the outer periphery of the base 1 for locking the base 1 to the kitchen ventilator. The base 1, the reflecting board 11 and the elastic locking piece 14 are connected by riveting method. Although, the reflecting board 11 can increase the luminance of the light bulb 12, this conventional lighting equipment of the kitchen ventilator still has the following disadvantages:

Firstly, the lighting device comprises the light bulb 12, besides the large amount of power consumption, the degree and the breadth of the irradiance of the lighting bulb 12 is still not great enough, despite the reflecting board 11 increases the brightness of the light bulb 12.

Secondly, the lighting equipment is assembled by riveting, therefore, it is very inconvenient for a user to replace or to assemble a component inside the base 1 since the riveting portion must be destroyed to open the base 1.

Thirdly, the light bulb 12 inside the kitchen ventilator is usually too dim for the cooker to see the food clearly, further, the light bulb 12 is power consuming and has a service life.

The present invention has arisen to mitigate and/or obviate the afore-described disadvantages.

### SUMMARY OF THE INVENTION

The primary objective of the present invention is to provide a lighting equipment for a kitchen ventilator, wherein the lighting equipment is not only power saving and has improved brightness, but also can be easily assembled and disassembled.

To obtain the abovementioned objective, the lighting equipment is provided in the housing of a kitchen ventilator with a plurality of LEDs. When the light equipment is turned on, power will be transmitted by a circuit to the LEDs, the LEDs are power saving, and the light of the LEDs is stable and irradiant,

Another objective of the present invention is to provide a lighting equipment for a kitchen ventilator, which can be easily assembled and disassembled.

The lighting equipment comprises a base, a plurality of elastic locking pieces, and a circuit board. The elastic locking pieces enables a quick installation of the lighting equipment into the kitchen ventilator housing. Further, the base, the plurality of elastic locking pieces, and the circuit board are assembled by using a single screw and a nut.

### BRIEF DESCRIPTION OF THE DRAWINGS

FIG. 1 is an exploded view of a conventional lighting equipment for a kitchen ventilator;

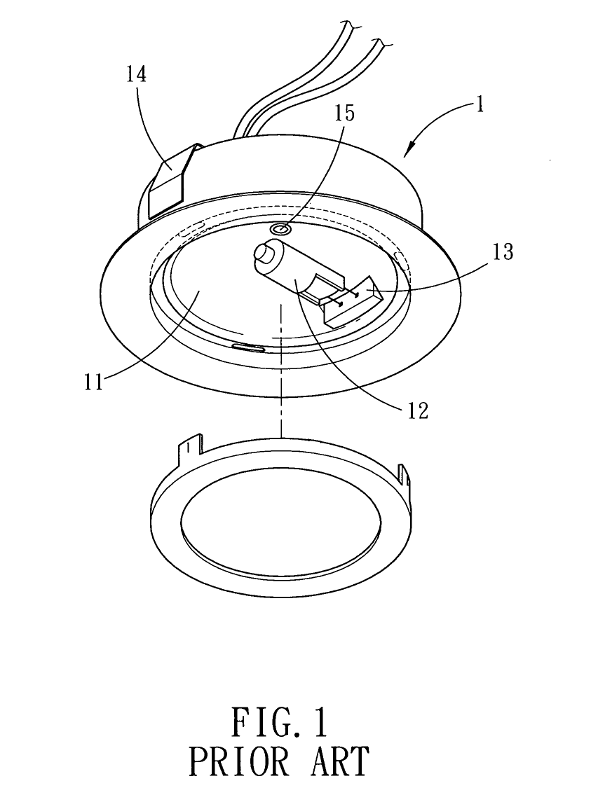

FIG. 2 shows that the conventional lighting equipment is installed in a kitchen ventilator;

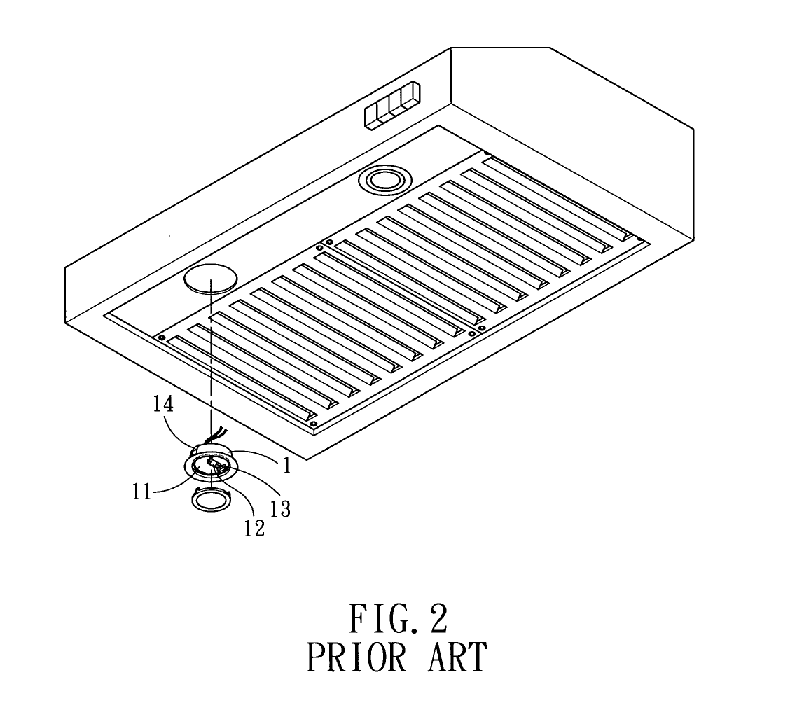

FIG. 3 is an exploded view of a lighting equipment for a kitchen ventilator in accordance with the present invention;

FIG. 4 is an exploded view of a lighting equipment for a kitchen ventilator in accordance with a second embodiment of the present invention;

FIG. 5 is an exploded view of a lighting equipment for a kitchen ventilator in accordance with a third embodiment of the present invention; and

FIG. 6 shows that the lighting equipment of the present invention is installed in a kitchen ventilator.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

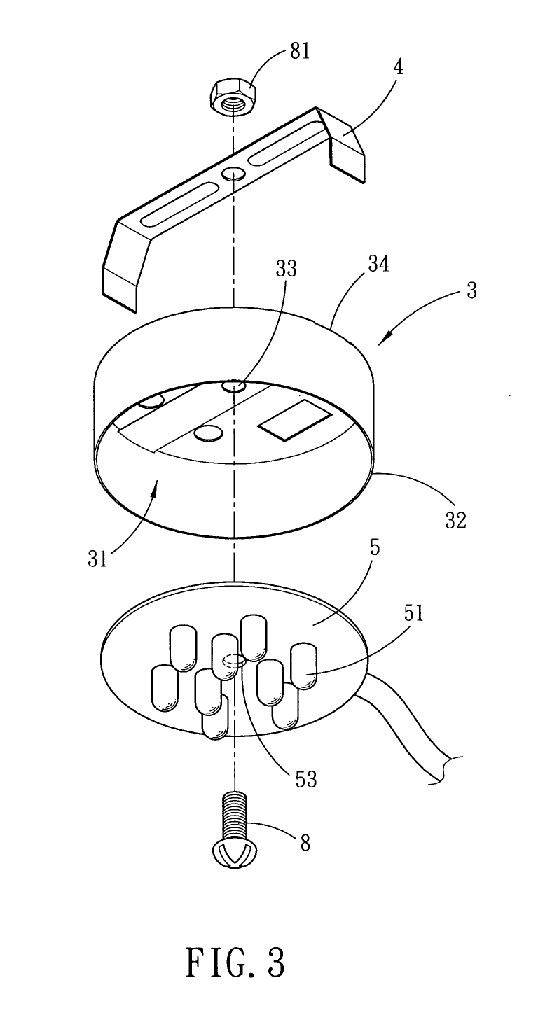

Referring to FIGS. 3-6, a lighting equipment for a kitchen ventilator in accordance with the present invention is installed in a mounting hole 91 of a housing 9 of a kitchen ventilator, and comprises: a base 3, an elastic locking piece 4, and a circuit board 5.

The base 3 is installed in the housing of the kitchen ventilator and is formed with a receiving space 31 that has an open end 32. A through hole 33 and a positioning groove 34 with two open ends are formed in a close end of the space opposite the open end 32.

The elastic locking piece 4 is formed with a through hole 43 to be aligned with the through hole 33 of the base 3 and is disposed in the positioning groove 34 of the base 3, and both ends of the elastic locking piece 4 protrude out of both ends of the positioning groove 34.

The circuit board 5 is provided with a plurality of LEDs 51 and is connected to the power source of the kitchen ventilator for supplying power to the LEDs 51. A through hole 53 is formed in the circuit board 5, and the circuit board 5 is installed in the receiving space 31 of the base 3. The through holes 33, 43, 53 of the base 3, the elastic locking piece 4, and the circuit board 5 are aligned with one another, and then a screw (such as a screw 8 and a nut 81) is inserted through the through holes to assemble the base 3, the elastic locking piece 4, and the circuit board 5 together quickly.

As shown in FIG. 3, the circuit board 5 provided with the LEDs 51 is assembled in the receiving space 31 of the base 3 initially, the elastic locking piece 4 is then inserted in the positioning groove 34 of the base 3, and two ends of the elastic locking piece 4 protrude therefrom, after that, the screw 8 is screwed through the through holes 33, 43, and 53 and into the nut 81. And finally, the elastic locking piece 4 is directly engaged in the mounting hole 91 of the housing 9. It is understood from the above description that the assembly of the present invention is very easy since the lighting equipment can be assembled or disassembled only by using a screw, further, it is also very easy to install the lighting equipment into the kitchen ventilator.

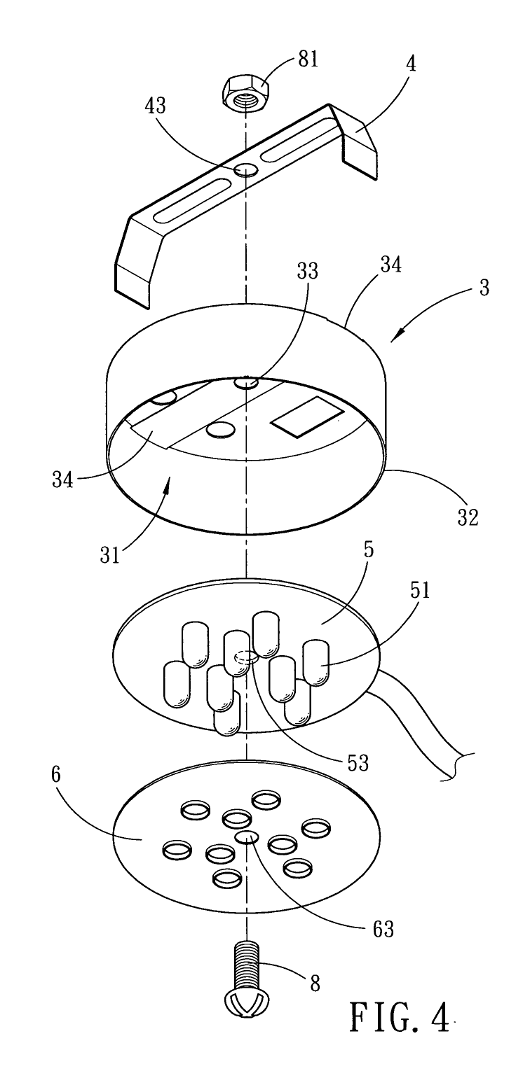

FIG. 4 shows a second embodiment of the present invention, as compared with the previous embodiment, the lighting equipment of this embodiment is additionally provided with a separating board 6 which is disposed in the receiving space 31 for passage of the LEDs 51 of the circuit board 5, and the circuit board 5 is located between the separating board 6 and the LEDs 51. The separating board 6 is coated with reflecting material for improving the brightness of the LEDs 51, and a through hole 63 is formed in the separating board 6 and is to be aligned with the through holes 33, 43, and 53. A screw is inserted through the through holes 33, 43, 53, and 63 to assemble the respective components together. And the function and operation of this embodiment are the same as the previous embodiment, so further descriptions are omitted.

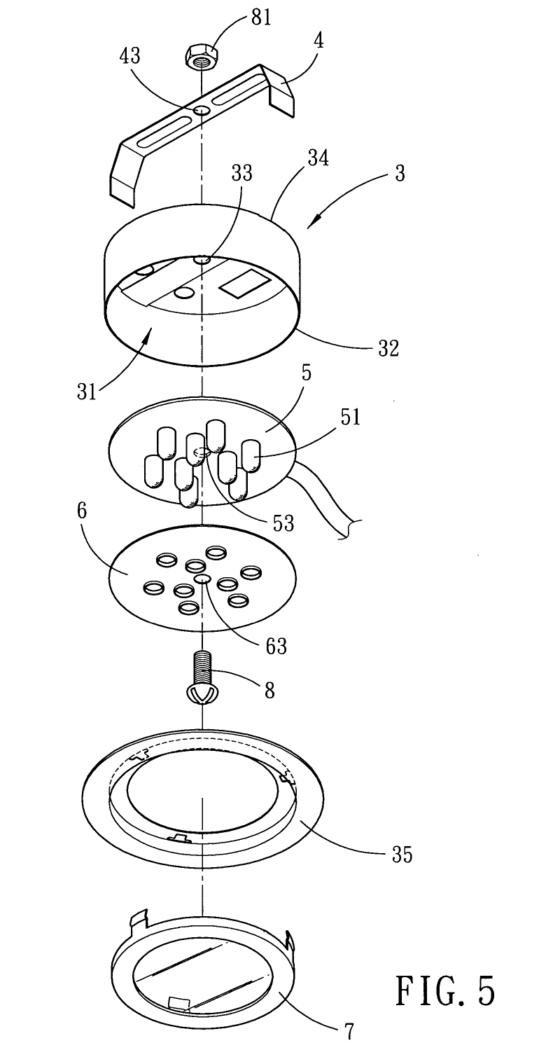

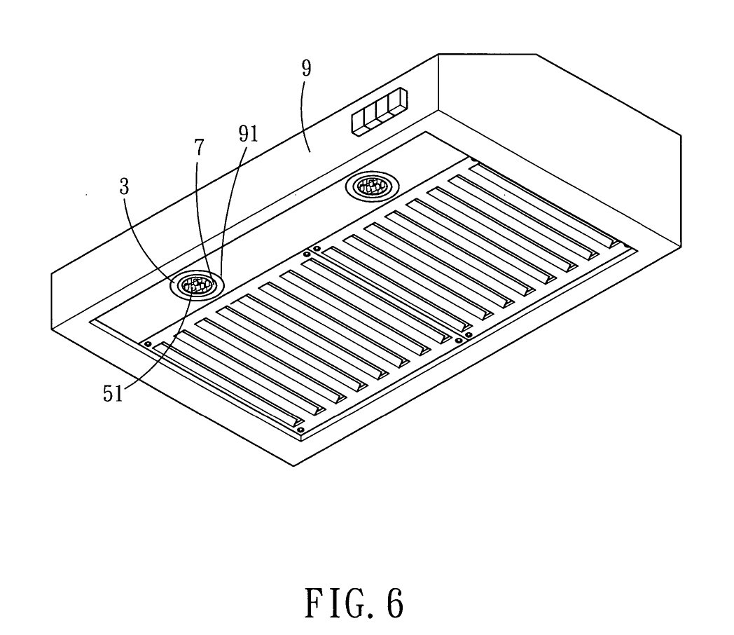

FIGS. 5 and 6 show a second embodiment of the present invention, as compared with the second embodiment, the lighting equipment of this embodiment is additionally provided with a covering board 7 that is used to cover the open end 32 of the base 3 after the circuit board 5 with the LEDs 51 and the separating board 6 are installed in the receiving spade 31 of the base 3. The cover board 7 is transparent and serves to protect the components inside the base 3 and allows the lights of the LEDs to be transmitted out of the covering board 7. A positioning board 35 is arranged at the open end 32 of the base 3 and is to be fixed to the covering board 7 in snap-fit fashion. The positioning board 35 is formed with a plurality of positioning holes for engaging with a plurality of positioning portions formed on the covering board 7, thus facilitating the assembly or disassembly of the covering board 7.

The LED 51 is power saving and has a long service life.

While we have shown and described various embodiments in accordance with the present invention, it is clear to those skilled in the art that further embodiments may be made without departing from the scope of the present invention.

What is claimed is:

1. A lighting equipment for a kitchen ventilator being disposed in a housing of a kitchen ventilator, comprising:
a base formed with a receiving space, the receiving space having an open end and a close end, a through hole and a positioning groove with two open ends being formed in the close end;
an elastic locking piece being formed with a through hole to be aligned with the through hole of the base, the elastic locking piece being disposed in the positioning groove of the base in such a manner that both ends of the elastic locking piece protrude out of the two open ends of the positioning groove;
a circuit board provided with a plurality of LEDs and being installed in the receiving space of the base, a through hole being formed in the circuit board and being aligned with the through hole of the elastic locking piece and the base; and
a screw positioned in the through hole of the circuit board, the elastic locking member, and the base.

2. The lighting equipment for a kitchen ventilator as claimed in claim 1, wherein a transparent covering board is disposed the open end of the base for protecting the components inside the base and for allowing for light transmission of the LEDs.

3. The lighting equipment for a kitchen ventilator as claimed in claim 1, wherein a separating board is positioned on the circuit board by the screw and is formed with a through hole, light of the LEDs passes through and is refracted by the separating board.

4. The lighting equipment for a kitchen ventilator as claimed in claim 1, wherein a transparent covering board is disposed the open end of the base for protecting the components inside the base and for allowing for light transmission of the LEDs, and a separating board is positioned on the circuit board by the screw and is formed with a through hole, light of the LEDs passes through and is refracted by the separating board.

5. The lighting equipment for a kitchen ventilator as claimed in claim 2, wherein a positioning board is arranged at the open end of the base and is formed with a plurality of positioning holes for engaging with a plurality of positioning portions formed on the covering board, thus facilitating the assembly or disassembly of the covering board.

6. The lighting equipment for a kitchen ventilator as claimed in claim 4, wherein a positioning board is arranged at the open end of the base and is formed with a plurality of positioning holes for engaging with a plurality of positioning portions formed on the covering board, thus facilitating the assembly or disassembly of the covering board.
